(19) United States
(12) Patent Application Publication
(10) Pub. No.: US 2020/0073019 A1
(43) Pub. Date: Mar. 5, 2020

(54) PROTECTIVE FILM FOR A LENS OF A SENSOR

(71) Applicant: GM GLOBAL TECHNOLOGY OPERATIONS LLC, DETROIT, MI (US)

(72) Inventors: Nathaniel W. Hart, Warren, MI (US); Adam L. Wright, Warren, MI (US); Adam F. Gross, Santa Monica (US); Anthony L. Smith, Troy (US)

(21) Appl. No.: 16/120,872

(22) Filed: Sep. 4, 2018

(51) Int. Cl. G02B 1/14; B29C 63/18; B29C 63/00

(52) U.S. Cl. CPC G02B 1/14; B29L 2031/752; B29C 63/0069; B29C 63/18

(57) ABSTRACT

A method of assembly includes providing a sensor having an electronic sensing unit operable to emit or receive light rays and a clear substrate attached to the electronic sensing unit. The method also includes providing a tubular protective wrap having a central orifice. The protective wrap has a transparent film layer and an interstitial layer. The interstitial layer is disposed on an interior surface of the film layer proximate the orifice. The method additionally includes disposing the protective wrap about the electronic sensing unit. The method further includes shrinking the protective wrap via application of heat such that the interstitial layer contacts at least a portion of the sensor with the film layer superposed over at least a portion of the clear substrate.

### TECHNICAL FIELD

The disclosure generally relates to a transparent film for covering a lens of a sensor.

### INTRODUCTION

Light emitting and/or receiving sensors may be located outside vehicles or buildings, and exposed to harsh environmental conditions. For example, many vehicles include light emitting and receiving sensors, such as but not limited to, cameras, LIDAR sensors, rangefinders, etc., which are positioned on the exterior of the vehicle and exposed to the elements. Light emitting and/or receiving sensors include a lens through which light rays must pass. The exterior surface of the lens should be protected from scratches and kept clean of dirt and debris in order to maintain adequate light transmission through the lens for proper functionality of the sensor.

### SUMMARY

A method of assembly according to the present disclosure includes providing a sensor having an electronic sensing unit operable to emit or receive light rays and a clear substrate attached to the electronic sensing unit. The method also includes providing a tubular protective wrap having a central orifice. The protective wrap has a transparent film layer and an interstitial layer. The interstitial layer is disposed on an interior surface of the film layer proximate the orifice. The method additionally includes disposing the protective wrap about the electronic sensing unit. The method further includes shrinking the protective wrap via application of heat such that the interstitial layer contacts at least a portion of the sensor with the film layer superposed over at least a portion of the clear substrate.

In an exemplary embodiment, the transparent film comprises a fluoropolymer. The fluoropolymer may include fluorinated ethylene propylene.

In an exemplary embodiment, the protective wrap further includes a surface coating disposed on an exterior surface of the film layer.

In an exemplary embodiment, shrinking the protective wrap via application of heat comprises elevating a temperature of the protective wrap to at least a glass transition temperature of the transparent film layer.

In an exemplary embodiment, the clear substrate exhibits a first index of refraction, the interstitial layer exhibits a second index of refraction, and the transparent film exhibits a third index of refraction, with the third index of refraction being less than the second index of refraction, and with the second index of refraction being less than the first index of refraction.

A sensor assembly according to the present disclosure includes an electronic sensing unit operable to emit or receive light rays. The assembly additionally includes a clear substrate attached to the electronic sensing unit and having a first surface. The first surface of the clear substrate is non-planar and operable for concentrating or dispersing light rays. The assembly further includes a protective cover superposed over the clear substrate. The protective cover includes a fluoropolymer layer having a first surface facing the first surface of the clear substrate and a second surface opposed to the first surface of the fluoropolymer layer. The protective cover also includes an interstitial layer disposed between the first surface of the fluoropolymer layer and the first surface of the clear substrate. The protective cover further includes a surface coating applied to the second surface of the fluoropolymer layer.

In an exemplary embodiment, the interstitial layer comprises adhesive.

In an exemplary embodiment, the protective cover comprises a tubular wrap disposed about at least a portion of the electronic sensing unit and the clear substrate.

In an exemplary embodiment, the tubular wrap is secured about the at least a portion of the electronic sensing unit and the clear substrate via heat shrinking.

In an exemplary embodiment, the clear substrate exhibits a first index of refraction, the interstitial layer exhibits a second index of refraction, the transparent film exhibits a third index of refraction, and the surface coating exhibits a fourth index of refraction, with the fourth index of refraction being less than the third index of refraction, the third index of refraction being less than the second index of refraction, and with the second index of refraction being less than the first index of refraction.

In an exemplary embodiment, the sensor assembly is coupled to an automotive vehicle.

In an exemplary embodiment, the fluoropolymer layer comprises fluorinated ethylene propylene.

A protective cover for a sensor according to an embodiment of the present disclosure includes a tubular fluoropolymer layer having a central orifice, a first surface proximate the central orifice, and a second surface opposed to the first surface. The tubular fluoropolymer layer exhibits a second index of refraction. The cover additionally includes an interstitial layer disposed on the first surface. The interstitial layer exhibits a first index of refraction. The cover further includes a surface coating applied to the second surface of the fluoropolymer layer. The surface coating comprises a third index of refraction. The third index of refraction is less than the second index of refraction, and the second index of refraction is less than the first index of refraction.

In an exemplary embodiment, the interstitial layer comprises adhesive.

In an exemplary embodiment, the fluoropolymer layer comprises fluorinated ethylene propylene.

In an exemplary embodiment, the fluoropolymer layer is provided with perforations.

In an exemplary embodiment, the cover is disposed about a sensor having a clear substrate. The sensor is disposed in the central orifice with the interstitial layer contacting the clear substrate.

Embodiments according to the present disclosure provide a number of advantages. For example, the present disclosure provides a system and method for protecting lenses of sensor assemblies. Such systems and methods may provide protection without inhibiting light transmission, and moreover be easily replaced as needed.

The above and other advantages and features of the present disclosure will be apparent from the following detailed description of the preferred embodiments when taken in connection with the accompanying drawings.

### BRIEF DESCRIPTION OF THE DRAWINGS

FIG. 1 is a first view of a method of protecting a sensor according to an embodiment of the present disclosure;

FIG. 2 a schematic cross-sectional view of a sensor, showing a protective wrap according to an embodiment of the present disclosure; and

FIGS. 3A-3C are views of a method of manufacturing a protective wrap according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

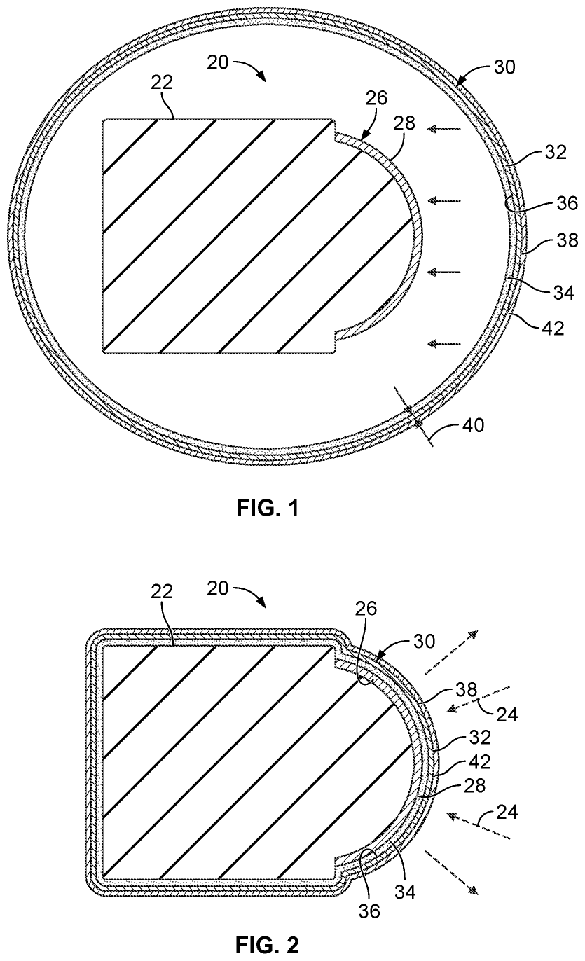

Referring to the FIGS., wherein like numerals indicate like parts throughout the several views, a sensor is generally shown at 20. Referring to FIGS. 1 and 2, the sensor 20 includes an electronic sensing unit 22 that is operable to emit and/or receive light rays 24 (shown in FIG. 2). The electronic sensing unit 22 may be configured, for example, as a range finder, a LIDAR sensor 20, a camera, or some other type of sensing device. The particular type, function and operation of the electronic sensing unit 22 is not critical to the teachings of this disclosure, and are therefore not described in detail herein. In the exemplary embodiment shown in the Figures and described herein, the electronic sensing unit 22 is generally square in cross-sectional shape. However, in other embodiments, the electronic sensing unit 22 may have other shapes, e.g. generally circular in cross-section.

The sensor 20 further includes a clear substrate 26, which is attached to the electronic sensing unit 22. As noted above, the electronic sensing unit 22 emits and/or receives light rays 24. The light rays 24 pass through the clear substrate 26. The clear substrate 26 may alternatively be referred to as a lens, a window, a pane, a panel, etc. The clear substrate 26 may be configured to concentrate or disperse the light rays 24 as the light rays 24 pass through the clear substrate 26. While depicted as extending about only a portion of the periphery of the electronic sensing unit 22 for illustrative purposes, in some embodiments the clear substrate 26 extends about the entire periphery of the electronic sensing unit 22. The clear substrate 26 includes a first surface 28. The first surface 28 of the clear substrate 26 may be considered an exterior or outer surface of the clear substrate 26. In the exemplary embodiment shown in the Figures and described herein, the first surface 28 of the clear substrate 26 is a non-planar surface. For example, the first surface 28 of the clear substrate 26 may include a concave surface of a convex surface, such as shown in the Figures. However, in other embodiments, the first surface 28 of the clear substrate 26 may include a planar surface. As is understood by those skilled in the art, the non-planar shape of the first surface 28 of the clear substrate 26 controls the concentration or dispersion of light rays 24 passing through the clear substrate 26.

The clear substrate 26 is a transparent material at particular frequencies, e.g. the frequency of the light rays 24. The clear substrate 26 may include and be manufactured from, but is not limited to, one of a glass material or a plastic material. For example, the clear substrate 26 may include and be manufactured from silica, borosilicate glass, quartz, polycarbonate Trivex by PPG™, CR-39 plastic, crown glass, or some other suitable transparent material.

The sensor 20 is provided with a tubular protective wrap 30, which is secured about a periphery of the electronic sensing unit 22, including the first surface 28 of the clear substrate 26. FIG. 1 shows the protective wrap 30 prior to being secured to the electronic sensing unit 22. FIG. 2 shows the protective wrap 30 secured to the electronic sensing unit 22 after a heat shrinking process. The protective wrap 30 includes a transparent film 32, an interstitial layer 34, and a surface coating 42. As used herein, the term “film” is defined as a solid material formed into a self-supporting layer. As used herein, the term “film” does not include a layer formed from a dried liquid.

The transparent film 32 includes a first surface 36 and an opposing second surface 38. The first surface 36 of the transparent film 32 is oriented inward, i.e. facing the electronic sensing unit 22. The second surface 38 of the transparent film 32 faces outward, i.e. facing away from the electronic sensing unit 22. Referring to FIG. 1, the transparent film 32 includes a thickness 40. In the exemplary embodiment described herein, the thickness 40 of the transparent film 32 is between 1 and 20 mils, and particularly between 3 and 8 mils. However, in other embodiments, the thickness 40 of the transparent film 32 may vary from the exemplary range provided herein.

In an exemplary embodiment, the transparent film 32 is at least 90% transparent, averaged from wavelengths of 400-2000 nm, and particularly at least 95%. The transparent film 32 may be configured to block light at wavelengths outside this range.

In an exemplary embodiment, the transparent film 32 comprises a thermoplastic material. The transparent film 32 may include, but is not limited to, a fluoropolymer. For example, in one exemplary embodiment, the transparent film 32 is fluorinated ethylene propylene (FEP). However, the transparent film 32 may include and be manufactured from other fluoropolymers, such as but not limited to Ethylene tetrafluoroethylene (EFTE), Perfluoroalkoxy alkane (PFA), amorphous fluoroplastics (AF), or an alternating copolymer of ethylene and tetrafluoroethylene (EFEP). In such embodiments, the fluoropolymer may have a water contact angle greater than 90° and a hexadecane contact angle greater than 45°. In other embodiments, the transparent film 32 includes a non-fluoropolymer material, e.g. a n organic polymer containing oxygen such as Polyethylene terephthalate (PET) or Polyetheretherketone (PEEK). In such embodiments, the material may have a water contact angle greater than 80°.

In an exemplary embodiment, the transparent film 32 has self-healing properties, e.g. through the inclusion of a viscous polymer layer or through the inclusion of microcapsules containing a moisture-cure adhesive such as cyanoacrylate or fluorocyanoacrylate.

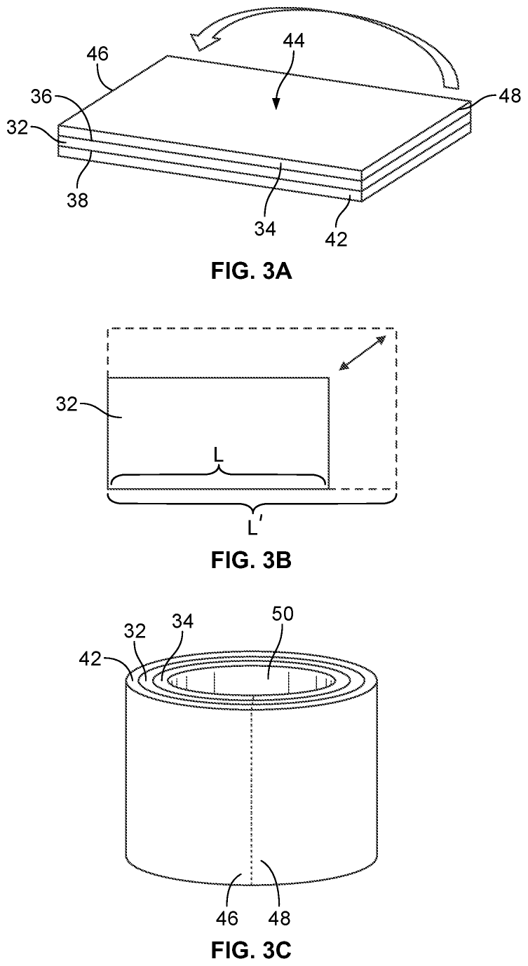

The transparent film 32 has been treated to form a heat-shrinkable film, shown in FIG. 1, which may be subsequently shrunk via a heat treatment, as shown in FIG. 2. The process of manufacture of the protective wrap 30 will be discussed in further detail below with respect to FIGS. 3-4. In an exemplary embodiment, the transparent film 32 has a shrinkage initiation temperature above the normal operating range of the sensor 20 but below the maximum storage temperature of the sensor 20.

The interstitial layer 34 is disposed on the first surface 36 of the transparent film 32. The interstitial layer 34 is provided to fill any gaps which may arise between the first surface 36 of the transparent film 32 and the first surface 28 of the clear substrate 26 during the shrinking of the transparent film 32. In various embodiments, the interstitial layer 34 may comprise a liquid, a gel, or a deformable solid. In an exemplary embodiment, the interstitial layer 34 comprises a liquid which is inorganic, an alkane, or organic, such as water, a fluorinated oil, a mineral oil, or a silicone fluid. In another exemplary embodiment, the interstitial layer 34 comprises a gel which contains a polymer. In another exemplary embodiment, the interstitial layer 34 comprises a solid polymer, which may be the same or different from the polymer of the transparent film, which undergoes plastic deformation. In yet another exemplary embodiment, the interstitial layer 34 comprises an adhesive, e.g. a pressure sensitive adhesive. The pressure sensitive adhesive can comprise linear or branched, random or block polymers having one, two, three or more monomer units. Example pressure sensitive adhesives can comprise a material chosen from the adhesives of acrylic resin, polyurethane, rubber, styrene-butadiene-styrene copolymers, ethylene vinyl acetate, styrene block copolymers, and combinations thereof, such as Styrene-ethylene/butylene-styrene (SEBS) block copolymer, Styrene-ethylene/propylene (SEP) block copolymer, Styrene-isoprene-styrene (SIS) block copolymer, or combinations thereof.

The second surface 38 of the transparent film 32 is treated to improve adhesion. As used herein, the phrase “treating for adhesion” is defined as using a process to clean and prepare a surface to increase surface adhesion. The second surface 38 of the transparent film 32 may be treated for adhesion using a suitable process. For example, the second surface 38 of the transparent film 32 may be treated for adhesion using one of an ozone treating process, a corona treating process, a chemical etching process, or a plasma treating process. The above noted exemplary processes for treating for adhesion are well known to those skilled in the art, and are therefore not described in detail herein.

A surface coating 42 is applied to the second surface 38. The surface coating 42 provides a desired property at the exterior of the sensor 20. In various embodiments, the surface coating 42 may include an anti-icing property, an anti-fouling property, an anti-scratch property, an anti-reflective property, an anti-abrasion property, a tint, reflective, or light-blocking property, or other properties as desired. The particular coating used in any given embodiment may be selected according to desired performance parameters, e.g. based on environmental factors. As an example, a protective wrap 30 intended for use in winter may include a surface coating 42 with anti-icing properties, while a protective wrap 30 intended for use in a sandy climate may include a surface coating 42 with anti-abrasion properties.

The clear substrate 26 exhibits an index of refraction. As understood by those skilled in the art, the “index of refraction” of a material is a dimensionless number that describes how light propagates through that material. According to various exemplary embodiments, the index of refraction may be 1.5 for a glass substrate, or 1.58 for a polycarbonate substrate. The interstitial layer 34, the transparent film 32, and the surface coating 42 also exhibit a respective index of refraction. In an exemplary embodiment, the materials used for the clear substrate 26, the interstitial layer 34, the transparent film 32, and the surface coating 42 may be selected such that the index of refraction of the surface coating 42 is less than the index of refraction of the transparent film 32. Furthermore, the index of refraction of the transparent film 32 is less than the index of refraction of the interstitial layer 34. Additionally, the index of refraction of the interstitial layer 34 may be less than the index of refraction of the clear substrate 26. By configuring the surface coating 42, transparent film 32, the interstitial layer 34, and the clear substrate 26 in this manner, i.e., with the index of refraction of the surface coating being less than the index of refraction of the transparent film, which is less than the index of refraction of the interstitial layer 34, which is less than the index of refraction of the clear substrate 26, the protective wrap 30 acts as an anti-reflection layer for the clear substrate 26, thereby improving light transmission through the clear substrate 26.

In order to assemble the sensor 20 with the protective wrap 30, the protective wrap 30 must first be prepared. Referring now to FIG. 3A, a multi-layer sheet 44 is manufactured. The sheet 44 comprises a first layer defined by the interstitial layer 34, a second layer defined by the transparent film 32, and a third layer defined by the surface coating 42. The sheet 44 is generally planar and extends from a first end 46 to a second end 48.

As described above, the second surface 38 of the transparent film 32 may be treated for adhesion in a suitable manner, including but not limited to, an ozone treating process, a corona treating process, a chemical etching process, or a plasma treating process. The second surface 38 of the transparent film 32 is treated for adhesion to improve the adhesion between the surface coating 42 and the transparent film 32. Once the second surface 38 of the transparent film 32 has been treated for adhesion, the surface coating 42 is applied to the second surface 38 of the transparent film 32. The manner in which the surface coating 42 is applied to the second surface 38 of the transparent film 32 is dependent upon the properties of the surface coating 42. For example, the surface coating 42 may be applied as a sheet, or may be applied in a liquid solution, and allowed to dry in order to form a film of the surface coating 42.

The interstitial layer 34 is applied to the first surface 36 of the transparent film 32. As discussed above, the interstitial layer 34 may comprise a liquid such as water or oil, a gel, an adhesive, or any material suitable for filling gaps between the first surface 28 of the clear substrate 26 and the first surface 36 of the transparent film 32.

The transparent film 32 is treated to form a heat-shrinkable film which may be subsequently shrunk via an application of heat, as illustrated in FIG. 3C. In an exemplary embodiment, the transparent film 32 is treated by applying a tensile force to deform the transparent film within the general plane of the transparent film 32 while maintaining the temperature of the transparent film 32 below the glass transition temperature. The tensile force may be uniaxial or biaxial with respect to the transparent film 32. This treatment may be performed prior to or subsequent to the application of the interstitial layer 34 and the surface coating 42, as appropriate based on the material properties of the interstitial layer 34 and the surface coating 42 for a particular embodiment. During the treatment, the transparent film 32 is expanded from an initial length L to an expanded length L′. In an exemplary embodiment, the initial length L is slightly smaller than the periphery of the sensor 20, while the expanded length L′ is between 5% and 100% greater than the initial length L, e.g. approximately 20% greater than the initial length L. In such an embodiment, the sensor 20 may thereby be accommodated within the protective wrap 30 in the expanded position, while in the shrunk position the protective wrap 30 will be secured to the periphery of the sensor 20. However, in other embodiments other relative sizes between the initial length L, the expanded length L′, and the periphery of the sensor 20 may be used, as appropriate for a given application.

The sheet 44 is formed into a tube having a central orifice 50, and the first end 46 is coupled to the second end 48, e.g. via heat-bonding, to maintain the tubular shape and form the protective wrap 30.

The protective wrap 30 is disposed about the sensor 20, e.g. with the sensor 20 arranged in the central orifice 50, as illustrated in FIG. 1. The assembly is then heated to at least a shrinkage initiation temperature, e.g. in an oven. The shrinkage initiation temperature refers to a temperature at which the transparent film 32 begins to contract to the initial shape. The shrinkage initiation temperature may correspond to the glass transition temperature of the transparent film 32, e.g. 80° C. for FEP, 90° C. for ETFE, 260° C. for AF, 100° C. for PFA, approximately 78° C. for PET, or 143° C. for PEEK. However, for some materials and configurations, shrinkage may initiate at a temperature below the glass transition temperature. Such shrinkage initiation temperatures may be obtained with minimal experimentation. As an example, experimentation on some FEP materials demonstrated shrinkage initiation at approximately 46° C.

The elevated temperature is maintained until a desired amount of shrinking has occurred, e.g. the protective wrap 30 is secured about the sensor 20 as illustrated in FIG. 2. In an exemplary embodiment, the desired amount of shrinking may correspond to a reduction of between 5% and 40% of length and width of the transparent film 32. The assembly is thereafter cooled.

At regular maintenance intervals, the protective wrap 30 may be easily removed from the clear substrate 26, and a new protective wrap 30 applied therein. In so doing, the sensor 20 may maintain a clear, clean, protective surface over the clear substrate 26. In some embodiments, features may be added to the protective wrap 30 to facilitate the removal process, e.g. perforations in the transparent film 32. The transparent fluoropolymer sheet of the protective wrap 30, e.g., fluorinated ethylene propylene, in combination with the interstitial layer 34 and surface coating 42, provide good light transmission through the clear substrate 26, do not degrade in response to UV exposure, maintain proper adhesion even when exposed to lens cleaning solvents such as window washer fluid, and easily shed dirt and other debris to keep the clear substrate 26 clean and protected. Furthermore, the type of protective wrap may be varied based on environmental condition. As an example, a protective wrap 30 with a surface coating 42 with anti-icing properties may be used in cold climates, while a protective wrap 30 with a surface coating 42 with anti-abrasion properties may be used in sandy climates. As an additional example, a superhydrophilic or highly hydrophilic surface coating may be used in climates with significant precipitation, e.g. rain, to facilitate shedding of water off the surface.

As an additional benefit, the protective wrap 30 may provide enhanced sealing function for the sensor 20, e.g. at interfaces between the electronic sensing unit 22 and the clear substrate 26.

Variations of the above are, of course, possible. As an example, steps of the manufacture and assembly of the protective wrap 30 may be performed in an order other than that described above, e.g. by bonding the sheet into tubular form prior to expansion. As another example, a non-tubular film, e.g. a half-spherical film, may be implemented. As yet another example, the interstitial layer may be omitted in some embodiments.

As may be seen the present disclosure provides a system and method for protecting lenses of sensor assemblies. Such systems and methods may provide protection without inhibiting light transmission, and moreover be easily replaced as needed.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method of assembly comprising:
providing a sensor having an electronic sensing unit operable to emit or receive light rays and a clear substrate attached to the electronic sensing unit;
providing a tubular protective wrap having a central orifice, the protective wrap comprising a transparent film layer and an interstitial layer, the interstitial layer being disposed on an interior surface of the film layer proximate the orifice;
disposing the protective wrap about the electronic sensing unit; and
shrinking the protective wrap via application of heat such that the interstitial layer contacts at least a portion of the sensor with the film layer superposed over at least a portion of the clear substrate.

2. The method of claim 1, wherein the transparent film comprises a fluoropolymer.

3. The method of claim 2, wherein the fluoropolymer comprises fluorinated ethylene propylene.

4. The method of claim 1, wherein the protective wrap further comprises a surface coating disposed on an exterior surface of the film layer.

5. The method of claim 1, wherein shrinking the protective wrap via application of heat comprises elevating a temperature of the protective wrap to at least a glass transition temperature of the transparent film layer.

6. The method of claim 1, wherein the clear substrate exhibits a first index of refraction, the interstitial layer exhibits a second index of refraction, and the transparent film exhibits a third index of refraction, with the third index of refraction being less than the second index of refraction, and with the second index of refraction being less than the first index of refraction.

7. A sensor assembly comprising:
an electronic sensing unit operable to emit or receive light rays;
a clear substrate attached to the electronic sensing unit and having a first surface, wherein the first surface of the clear substrate is non-planar and operable for concentrating or dispersing light rays;
a protective cover superposed over the clear substrate, the protective cover including a fluoropolymer layer having a first surface facing the first surface of the clear substrate and a second surface opposed to the first surface of the fluoropolymer layer, an interstitial layer disposed between the first surface of the fluoropolymer layer and the first surface of the clear substrate, and a surface coating applied to the second surface of the fluoropolymer layer.

8. The sensor assembly of claim 7, wherein the interstitial layer comprises a distinct material from the fluoropolymer layer.

9. The sensor assembly of claim 8, wherein the interstitial layer comprises adhesive.

10. The sensor assembly of claim 7, wherein the protective cover comprises a tubular wrap disposed about at least a portion of the electronic sensing unit and the clear substrate.

11. The sensor assembly of claim 10, wherein the tubular wrap is secured about the at least a portion of the electronic sensing unit and the clear substrate via heat shrinking.

12. The sensor assembly of claim 7, wherein the clear substrate exhibits a first index of refraction, the interstitial layer exhibits a second index of refraction, the transparent film exhibits a third index of refraction, and the surface coating exhibits a fourth index of refraction, with the fourth index of refraction being less than the third index of refraction, the third index of refraction being less than the second index of refraction, and with the second index of refraction being less than the first index of refraction.

13. The sensor assembly of claim 7, wherein the sensor assembly is coupled to an automotive vehicle.

14. The sensor assembly of claim 7, wherein the fluoropolymer layer comprises fluorinated ethylene propylene.

15. A protective cover for a sensor, comprising:
a tubular fluoropolymer layer having a central orifice, a first surface proximate the central orifice, and a second surface opposed to the first surface, the tubular fluoropolymer layer exhibiting a second index of refraction;
an interstitial layer disposed on the first surface, the interstitial layer exhibiting a first index of refraction; and
a surface coating applied to the second surface of the fluoropolymer layer, the surface coating comprising a third index of refraction, with the third index of refraction being less than the second index of refraction, and with the second index of refraction being less than the first index of refraction.

16. The protective cover of claim 15, wherein the interstitial layer comprises adhesive.

17. The protective cover of claim 15, wherein the fluoropolymer layer comprises fluorinated ethylene propylene.

18. The protective cover of claim 15, wherein the fluoropolymer layer is provided with perforations.

19. The protective cover of claim 15, further comprising a sensor having a clear substrate, the sensor being disposed in the central orifice with the interstitial layer contacting the clear substrate.
